(19) United States
(12) Patent Application Publication
(10) Pub. No.: US 2025/0392188 A1
(43) Pub. Date: Dec. 25, 2025

(54) ELECTRIC COMPRESSOR

(71) Applicant: DENSO CORPORATION, Kariya-city (JP)

(72) Inventors: Yukinori SUZUKI, Kariya-city (JP); Masashi HIGASHIYAMA, Kariya-city (JP)

(21) Appl. No.: 19/309,128

(22) Filed: Aug. 25, 2025

Related U.S. Application Data
(63) Continuation of application No. PCT/JP2024/009690, filed on Mar. 13, 2024.

(30) Foreign Application Priority Data
Mar. 15, 2023 (JP) 2023-040787

(51) Int. Cl. H02K 5/22; F25B 31/02; H02K 11/33; H02K 21/14

(52) U.S. Cl. CPC H02K 5/225; F25B 31/02; H02K 11/33; H02K 21/14; H02K 2211/03

(57) ABSTRACT

An electric compressor includes a pressure vessel, a control box and a hermetic terminal. The pressure vessel and the control box are integrally formed. The pressure vessel receives an electric motor unit configured to rotate upon receiving electric power and a compression mechanism configured to be driven by the electric motor unit to compress and discharge a flammable fluid. The control box receives an electric circuit board configured to supply the electric power to the electric motor unit. The hermetic terminal includes at least one electrical conductor pin which electrically connects between the electric motor unit and the electric circuit board and is glass-sealed in a fixing plate. In the electric compressor, a vessel-side seal is disposed between the fixing plate and the pressure vessel to limit leakage of the flammable fluid present in the pressure vessel to a surrounding atmosphere.

### CROSS REFERENCE TO RELATED APPLICATIONS

This application is a continuation application of International Patent Application No. PCT/JP2024/009690 filed on Mar. 13, 2024, which designated the U.S. and claims the benefit of priority from Japanese Patent Application No. 2023-40787 filed on Mar. 15, 2023. The entire disclosures of all of the above applications are incorporated herein by reference.

### TECHNICAL FIELD

The present disclosure relates to an electric compressor.

### BACKGROUND

Previously, an electric compressor applied to a refrigeration cycle apparatus has been proposed. In recent years, the use of natural refrigerants with low global warming potential has been increasingly demanded as refrigerants for refrigeration cycle apparatuses. Some natural refrigerants, such as propane, are flammable fluids.

### SUMMARY

This section provides a general summary of the disclosure, and is not a comprehensive disclosure of its full scope or all of its features.

According to the present disclosure, there is provided an electric compressor that may include a pressure vessel, a control box and a hermetic terminal. The pressure vessel may receive an electric motor unit and a compression mechanism. The electric motor unit may be configured to rotate upon receiving electric power. The compression mechanism may be configured to be driven by the electric motor unit to compress and discharge a flammable fluid. The control box may receive an electric circuit board which may be configured to supply the electric power to the electric motor unit. The hermetic terminal may include at least one electrical conductor pin which may electrically connect between the electric motor unit and the electric circuit board and may be glass-sealed in a fixing plate that may be shaped in a flat plate form and may hold the at least one electrical conductor pin. The pressure vessel and the control box may be integrally formed. The vessel-side seal may be disposed between the fixing plate and the pressure vessel to limit leakage of the flammable fluid, which is present in the pressure vessel, to a surrounding atmosphere.

### BRIEF DESCRIPTION OF DRAWINGS

The drawings described herein are for illustrative purposes only of selected embodiments and not all possible implementations, and are not intended to limit the scope of the present disclosure.

FIG. 1 is an axial cross-sectional view showing a compressor according to a first embodiment.

FIG. 2 is an explanatory view showing a structure of a connection between a housing and a control box according to the first embodiment.

FIG. 3 is an explanatory view showing a structure of the connection between the housing and the control box according to a second embodiment.

FIG. 4 is an explanatory view showing a structure of the connection between the housing and the control box according to a third embodiment.

FIG. 5 is an explanatory view showing a structure of the connection between the housing and the control box according to a fourth embodiment.

### DETAILED DESCRIPTION

Previously, an electric compressor applied to a refrigeration cycle apparatus has been proposed. In recent years, the use of natural refrigerants with low global warming potential has been increasingly demanded as refrigerants for refrigeration cycle apparatuses. Some natural refrigerants, such as propane, are flammable fluids.

In the previously proposed electric compressor, an electric motor unit, a compression mechanism and a control box are integrally formed. In such an electric compressor, it is demanded to limit intrusion of a flammable refrigerant into an inside of the control box. Therefore, it is necessary to take sufficient measures, such as welding, to secure the electrical connection between the electric motor unit and the electric control device. As a result, it leads to a decrease in the productivity of the electric compressor.

According to one aspect of the present disclosure, there is provided an electric compressor including:
a pressure vessel that receives:
   an electric motor unit which is configured to rotate upon receiving electric power; and
   a compression mechanism which is configured to be driven by the electric motor unit to compress and discharge a flammable fluid;
a control box that receives an electric circuit board which is configured to supply the electric power to the electric motor unit; and
a hermetic terminal that includes at least one electrical conductor pin which electrically connects between the electric motor unit and the electric circuit board and is glass-sealed in a fixing plate that is shaped in a flat plate form and holds the at least one electrical conductor pin, wherein:
the pressure vessel and the control box are integrally formed; and
a vessel-side seal is disposed between the fixing plate and the pressure vessel to limit leakage of the flammable fluid, which is present in the pressure vessel, to a surrounding atmosphere.

Accordingly, since the vessel-side seal is disposed, it is possible to limit the high-pressure flammable fluid inside the pressure vessel from leaking to the surrounding atmosphere. Moreover, even if the flammable fluid slightly leaks through the vessel-side seal, the leaked fluid can be entirely discharged into the surrounding atmosphere. Accordingly, the electric compressor can be applied to a refrigeration cycle apparatus without causing a decrease in productivity.

Hereinafter, embodiments of the present disclosure will be described with reference to the drawings. In each of the following embodiments, the same reference signs may be assigned to portions that are the same as or equivalent to those described in the preceding embodiment(s), and the description thereof may be omitted. Further, when only any one or more of the components are described in the embodiment, the description of the rest of the components described in the preceding embodiment may be applied to the rest of the components. In addition to the combinations of portions that are specifically shown to be combinable in the respective embodiments, it is also possible to partially combine the embodiments even if they are not specifically shown, provided that the combinations are not impeded.

### First Embodiment

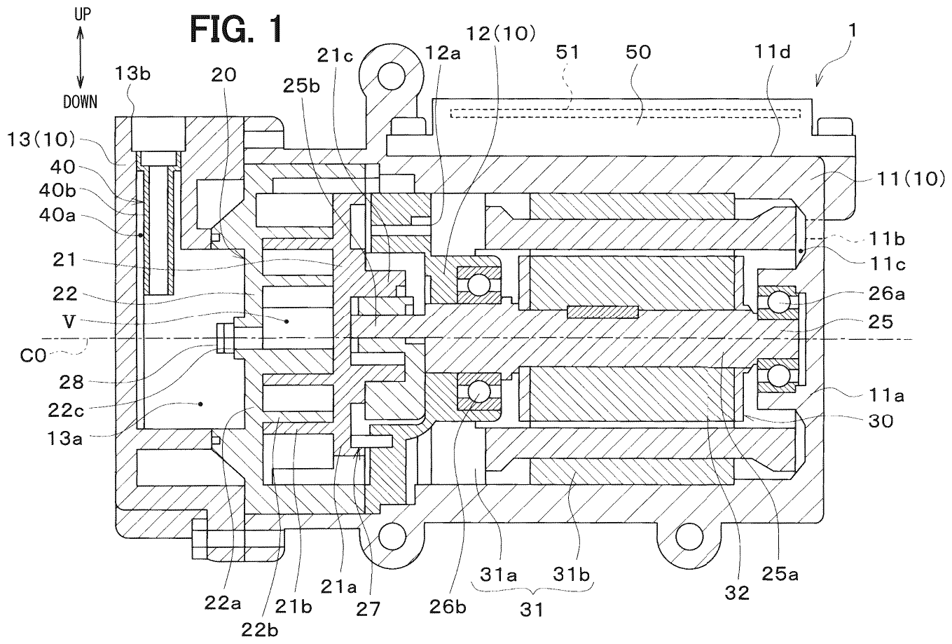

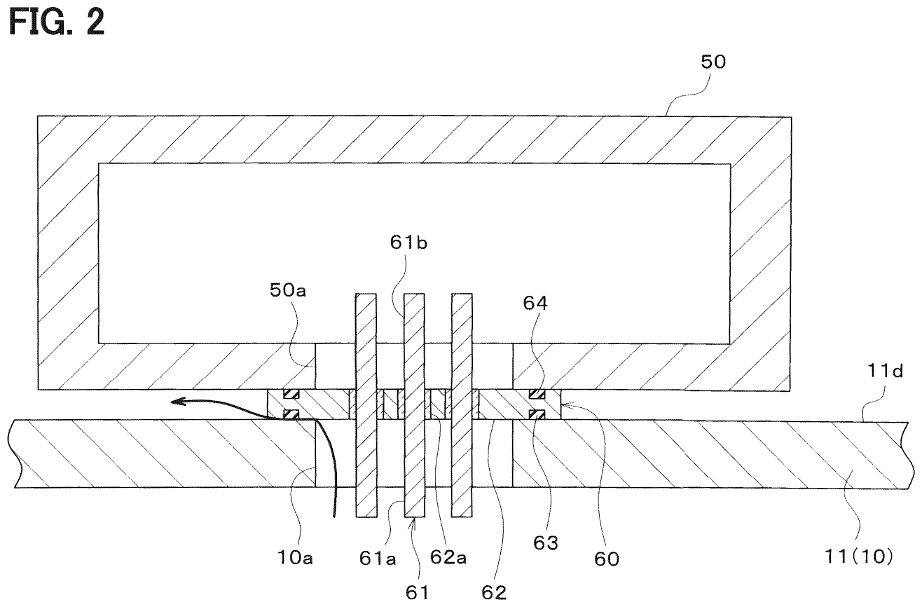

The first embodiment of the present disclosure will be described with reference to FIGS. 1 and 2. A scroll compressor 1 (hereinafter simply referred to as the compressor 1) of the present embodiment is applied to a vapor-compression refrigeration cycle for adjusting the temperature of blown air to be delivered into a vehicle cabin by a vehicle air conditioning apparatus. The compressor 1 is configured to suction, compress and discharge the refrigerant in the refrigeration cycle.

The refrigeration cycle includes a condenser, an expansion valve, an evaporator and the compressor 1 which are connected in a circuit via, for example, refrigerant pipes. The condenser causes heat exchange between the high-pressure refrigerant discharged from the compressor 1 and ambient air, thereby releasing heat from the high-pressure refrigerant. The expansion valve reduces the pressure of the refrigerant that has released the heat in the condenser. The evaporator causes heat exchange between the low-pressure refrigerant, which has been depressurized by the expansion valve, and the blown air, thereby evaporating the low-pressure refrigerant.

In the refrigeration cycle of the present embodiment, a flammable fluid (hereinafter also referred to as a flammable refrigerant) is employed as the refrigerant. Specifically, propane (R290) is employed as the refrigerant. The propane is a natural refrigerant with a low global warming potential, but the propane is flammable. Furthermore, the refrigerant contains refrigeration oil (lubricating oil) for lubricating sliding portions inside the compressor 1, and a portion of the refrigeration oil circulates through the cycle together with the refrigerant.

Next, the detailed structure of the compressor 1 will be described. The compressor 1 of the present embodiment is disposed in an engine room of the vehicle and is configured as an electric compressor that operates upon receiving electric power.

More specifically, as shown in FIG. 1, a housing 10 of the compressor 1 receives a scroll compression mechanism 20 (hereinafter simply referred to as the compression mechanism 20), an electric motor 30 and a shaft 25. The housing 10 forms an outer shell of the compressor 1. The electric motor 30 rotationally drives the compression mechanism 20. The shaft 25 is a rotatable shaft that transmits rotational drive force from the electric motor 30 to the compression mechanism 20.

It should be noted that an upward arrow and a downward arrow in FIG. 1 indicate upward and downward directions of the compressor 1 when it is applied to the vehicle air conditioning apparatus (i.e., when mounted in the vehicle). Accordingly, the compressor 1 of the present embodiment is configured as a so-called horizontally mounted type, in which a rotational axis of the shaft 25 extends in the horizontal direction, and the compression mechanism 20 and the electric motor 30 are arranged in the horizontal direction.

The housing 10 is a pressure vessel having a sealed vessel structure formed by combining a plurality of metal members. More specifically, the housing 10 of the present embodiment includes a front housing 11, a middle housing 12 and a rear housing 13. The front housing 11 is shaped in a bottomed cylindrical form (cup form). The middle housing 12 is disposed inside the front housing 11 and partitions an inside space of the housing 10. The rear housing 13 closes an opening of the front housing 11.

The front housing 11, the middle housing 12 and the rear housing 13 are integrally assembled by means such as press fitting or bolting. In addition, seal members such as O-rings or gaskets are interposed at the respective interfaces between each pair of the front housing 11, the middle housing 12 and the rear housing 13. As a result, the refrigerant does not leak from the respective interfaces.

A suction port 11b is formed in a bottom portion 11a that defines one end of the front housing 11 which faces in an axial direction. The low-pressure refrigerant from an outside of the housing 10 (specifically, the low-pressure refrigerant discharged from the evaporator of the refrigeration cycle) is suctioned through the suction port 11b. The suction port 11b is communicated with a motor-side space 11c that receives the electric motor 30. The low-pressure refrigerant, which is suctioned through the suction port 11b, flows into the motor-side space 11c.

Furthermore, a flat surface 11d, which extends substantially in the horizontal direction, is formed on an outer peripheral surface of a tubular portion of the front housing 11. A control box 50, which is formed integrally with the housing 10, is mounted on the flat surface 11d. An electric circuit board 51 is received in the control box 50. A drive circuit (not shown), which supplies the electric power to the electric motor 30, is mounted on the electric circuit board 51. Accordingly, in the compressor 1 of the present embodiment, the low-pressure refrigerant, which flows into the motor-side space 11c through the suction port 11b, can cool the electric motor 30 and the drive circuit.

The electric motor 30 is an electric motor unit that rotates upon receiving the electric power. The electric motor 30 is disposed on the inner periphery of the tubular portion of the front housing 11. The electric motor 30 outputs rotational drive force to drive the compression mechanism 20. More specifically, the electric motor 30 includes a stator 31, which serves as a stationary element, and a rotor 32, which serves as a rotatable element. In the present embodiment, the electric motor 30 is configured as a three-phase motor.

The stator 31 is fixed to the inner peripheral surface of the tubular portion of the front housing 11. The stator 31 includes a stator core 31a, which is made of a magnetic material, and stator coils 31b, which are wound around the stator core 31a. When the electric power is supplied from the drive circuit to the stator coils 31b, a rotating magnetic field is generated to rotate the rotor 32.

The rotor 32 includes permanent magnets and is disposed on the radially inner side of the stator 31. Furthermore, the rotor 32 is shaped in a cylindrical form that extends in an axial direction of a rotational axis of the rotor 32. A columnar portion 25a of the shaft 25 made of metal is securely press-fitted into a central axial hole of the rotor 32.

The shaft 25 has the columnar portion 25a and an eccentric portion 25b. The columnar portion 25a is shaped in a substantially cylindrical form that extends coaxially with a central axis C0 (rotational central axis) of the shaft 25. The eccentric portion 25b is disposed eccentrically with respect to the central axis C0. The eccentric portion 25b is shaped in a substantially cylindrical form that extends parallel to the central axis C0.

Furthermore, the columnar portion 25a of the shaft 25 is formed to have an axial length longer than that of the rotor 32. One end portion of the columnar portion 25a, which faces in the axial direction, is rotatably supported by a motor-side bearing 26a. The motor-side bearing 26a is disposed at a substantially central portion of the bottom portion 11a of the front housing 11. The other end portion of the columnar portion 25a, which faces toward the compression mechanism 20 in the axial direction, is rotatably supported by a compression-mechanism-side bearing 26b. The compression-mechanism-side bearing 26b is disposed at a substantially central portion of the middle housing 12, which is shaped in a substantially circular disk form.

Accordingly, when the rotating magnetic field is generated upon supplying the electric power to the stator coils 31b, the rotor 32 and the shaft 25 are integrally rotated. An outer peripheral surface of the middle housing 12 is press-fitted into an inner peripheral surface of the tubular portion of the front housing 11. The middle housing 12 partitions the inside space of the housing 10 into the motor-side space 11c, in which the electric motor 30 is received, and a compression-mechanism-side space, in which the compression mechanism 20 is received.

The compression mechanism 20 is a compression mechanism configured to be driven by the electric motor 30 to compress and discharge the refrigerant. The compression mechanism 20 includes a movable scroll 21 and a stationary scroll 22, which are made of a metal (e.g., an aluminum alloy), as a pair of scrolls. Each of the movable scroll 21 and the stationary scroll 22 has: a base plate which is shaped in a flat plate form; and a wrap which is shaped in a spiral form and projects from the base plate in the axial direction of the shaft 25.

Specifically, the movable scroll 21 includes: a movable base plate 21a, which is shaped in a circular plate form; and a movable wrap 21b, which is shaped in a spiral form and projects from the movable base plate 21a toward the stationary scroll 22. The stationary scroll 22 includes: a stationary base plate 22a, which is shaped in a circular plate form; and a stationary wrap 22b, which is shaped in a spiral form and projects from the stationary base plate 22a toward the movable scroll 21.

Further, the stationary scroll 22 is fixed to the front housing 11 by press-fitting an outer peripheral surface of the stationary base plate 22a into the inner peripheral surface of the tubular portion of the front housing 11. The movable scroll 21 is disposed in a space formed between the middle housing 12 and the stationary scroll 22

The movable scroll 21 and the stationary scroll 22 are arranged such that a plate surface of the base plate 21a and a plate surface of the base plate 22a are opposed to each other. The movable scroll 21 and the stationary scroll 22 are arranged such that the wraps 21b, 22b are meshed with each other, and a distal end of the wrap 21b, 22b of each of the scrolls 21, 22 is in contact with the base plate 21a, 22a of the other one of the scrolls 21, 22.

As a result, the wraps 21b, 22b are brought into contact with each other at a plurality of locations, and thereby a plurality of working chambers V, each having a crescent shape when viewed in the axial direction of the rotational axis, are formed between the wraps 21b, 22b. In FIG. 1, for clarity of illustration, only one of the plurality of working chambers V is denoted with a reference sign, and the other working chambers are not labeled.

A boss 21c, which is shaped in a cylindrical tubular form, is formed at a central portion of the movable base plate 21a of the movable scroll 21 and receives the other end portion (the compression mechanism 20 side end portion) of the shaft 25. As described above, the eccentric portion 25b, which is disposed eccentrically with respect to the rotational center of the shaft 25, is formed at the other end portion of the shaft 25. Accordingly, the eccentric portion 25b of the shaft 25 is inserted into the movable scroll 21.

A self-rotation limiting mechanism 27 is provided between the movable scroll 21 and the middle housing 12. The self-rotation limiting mechanism 27 prevents the movable scroll 21 from rotating about the eccentric portion 25b. Accordingly, when the shaft 25 is rotated, the movable scroll 21 orbits (i.e., performs a revolving motion) relative to the stationary scroll 22 about the central axis C0 serving as the center of revolution, without rotating around the eccentric portion 25b.

Then, due to this revolving motion, the above-described working chamber V is displaced from the outer peripheral side toward the center side around the rotational axis, while its volume decreases. In the present embodiment, the self-rotation limiting mechanism 27 is of a pin-and-hole type. However, other types (e.g., an Oldham ring type) may also be employed.

The middle housing 12 of the present embodiment is formed with a suction-side communication passage 12a that places the working chamber V, which is displaced to the radially outermost side and has a maximum volume, in communication with the motor-side space 11c.

A discharge hole 22c, which is configured to discharge the refrigerant compressed in the working chamber V, is formed at the center of the stationary base plate 22a of the stationary scroll 22. The discharge hole 22c is communicated with a discharge chamber 13a, which is configured to receive the high-pressure refrigerant compressed in the working chamber V. A reed valve 28 is disposed in the discharge chamber 13a. The reed valve 28 limits backflow of the refrigerant from the discharge chamber 13a to the working chamber V through the discharge hole 22c.

The discharge chamber 13a is defined by a space between the stationary scroll 22 and the rear housing 13. A refrigerant outlet of the discharge chamber 13a is communicated with an oil separator 40 formed inside the rear housing 13.

The oil separator 40 separates the refrigeration oil from the high-pressure refrigerant compressed by the compression mechanism 20. More specifically, the oil separator 40 is formed by disposing a pipe member 40b, which has a smaller diameter than a cylindrical space 40a, in the cylindrical space 40a that extends in the vertical direction (i.e., the up-down direction) in the rear housing 13.

The refrigeration oil, which is separated by the oil separator 40, is guided to sliding portions of the compression mechanism 20 and the electric motor 30 through an oil passage (not shown) formed in the rear housing 13, the stationary scroll 22 and the middle housing 12. Meanwhile, the high-pressure refrigerant, which is separated by the oil separator 40, is guided to a discharge port 13b that is formed in the rear housing 13 and discharges the high-pressure refrigerant to the outside of the housing 10.

Next, a connection between the housing 10 and the control box 50 in the compressor 1 of the present embodiment will be described.

As shown in FIG. 2, a hermetic terminal (also referred to as a hermetic feedthrough) 60 is provided at the connection between the housing 10 and the control box 50. Specifically, the hermetic terminal 60 is provided at the connection between the front housing 11 of the housing 10 and the control box 50.

The hermetic terminal 60 includes a plurality of electrical conductor pins 61 and a fixing plate 62. Each of the electrical conductor pins 61 is a conductor member configured to electrically connect between the electric motor 30 and the electric circuit board 51. In the present embodiment, since the electric motor 30 is configured as the three-phase motor, three electrical conductor pins 61 are provided.

The fixing plate 62 is a metal member which is shaped in a flat plate form and holds the electrical conductor pins 61. The fixing plate 62 has a plurality of through-holes 62a through which the electrical conductor pins 61 are respectively inserted. The electrical conductor pins 61 are glass-sealed to the fixing plate 62 in a state where the electrical conductor pins 61 are inserted through the through-holes 62a, respectively. In the present embodiment, since the three electrical conductor pins 61 are provided, the number of the through-holes 62a formed in the fixing plate 62 is three. Each of the electrical conductor pins 61 is inserted through the corresponding one of the through-holes 62a.

Two opposite end portions of each electrical conductor pin 61 project from the fixing plate 62. A portion of the electrical conductor pin 61, which projects from the fixing plate 62 toward the housing 10, is referred to as a vessel-side end portion 61a. Another portion of the electrical conductor pin 61, which projects from the fixing plate 62 toward the control box 50, is referred to as a box-side end portion 61b.

A vessel-side through-hole 10a, through which the vessel-side end portions 61a of the electrical conductor pins 61 are inserted, is formed at a connecting portion of the housing 10 connected to the control box 50. A box-side through-hole 50a, through which the box-side end portions 61b of the electrical conductor pins 61 are inserted, is formed through a connecting portion of the control box 50 connected to the housing 10. A diameter of the fixing plate 62 is larger than diameters of both the vessel-side through-hole 10a and the box-side through-hole 50a.

In the present embodiment, the single vessel-side through-hole 10a is formed in the housing 10. The vessel-side end portions 61a of the three electrical conductor pins 61 are inserted through the single vessel-side through-hole 10a. Furthermore, the single box-side through-hole 50a is formed in the control box 50. The box-side end portions 61b of the three electrical conductor pins 61 are inserted through the single box-side through-hole 50a.

A gasket 63 is provided between the fixing plate 62 and the housing 10. The gasket 63 is a vessel-side seal configured to limit leakage of the flammable refrigerant from the inside of the housing 10 to the surrounding atmosphere. It is preferable to employ, as the gasket 63, a material that allows a slight permeation of the refrigerant therethrough. Therefore, in the present embodiment, the gasket 63, which is made of a rubber material, is employed.

An O-ring 64 is provided between the fixing plate 62 and the control box 50. The O-ring 64 is a box-side seal configured to limit inflow of air (atmospheric gas) from the surrounding atmosphere into an inside of the control box 50. In the present embodiment, the O-ring 64, which is made of a rubber material, is employed.

As described above, in the compressor 1 of the first embodiment, the hermetic terminal 60 is provided at the connection between the housing 10 and the control box 50. The gasket 63, which limits leakage of the flammable refrigerant from inside the housing 10 to the surrounding atmosphere, is disposed between the fixing plate 62 of the hermetic terminal 60 and the housing 10.

Accordingly, since the gasket 63 is disposed, leakage of the high-pressure flammable refrigerant from an inside of the housing 10 to the surrounding atmosphere can be limited. Moreover, as indicated by an arrow in FIG. 2, even when the flammable refrigerant slightly leaks through the gasket 63, the flammable refrigerant can be entirely discharged into the surrounding atmosphere. Meanwhile, in the hermetic terminal 60, since the electrical conductor pins 61 and the fixing plate 62 are sealed by the glass sealing, the flammable refrigerant does not leak slightly through the sealing portion between the electrical conductor pins 61 and the fixing plate 62. Therefore, inflow of the flammable refrigerant into the control box 50 can be limited.

Accordingly, the inflow of the flammable refrigerant into the control box 50 can be limited without taking measures such as welding and fixing the electrical connection that connects between the electric motor 30 and the control box 50. As a result, the compressor 1 can be applied to the refrigeration cycle apparatus without causing a reduction in productivity.

In the compressor 1 of the first embodiment, the O-ring (box-side seal) 64, which limits the inflow of the air from the surrounding atmosphere into the inside of the control box 50, is disposed between the fixing plate 62 of the hermetic terminal 60 and the control box 50. Accordingly, even when the flammable refrigerant slightly leaks to the surrounding atmosphere through the gasket 63, the leaked flammable refrigerant can be limited from flowing into the control box 50 through a gap between the fixing plate 62 and the control box 50.

### Second Embodiment

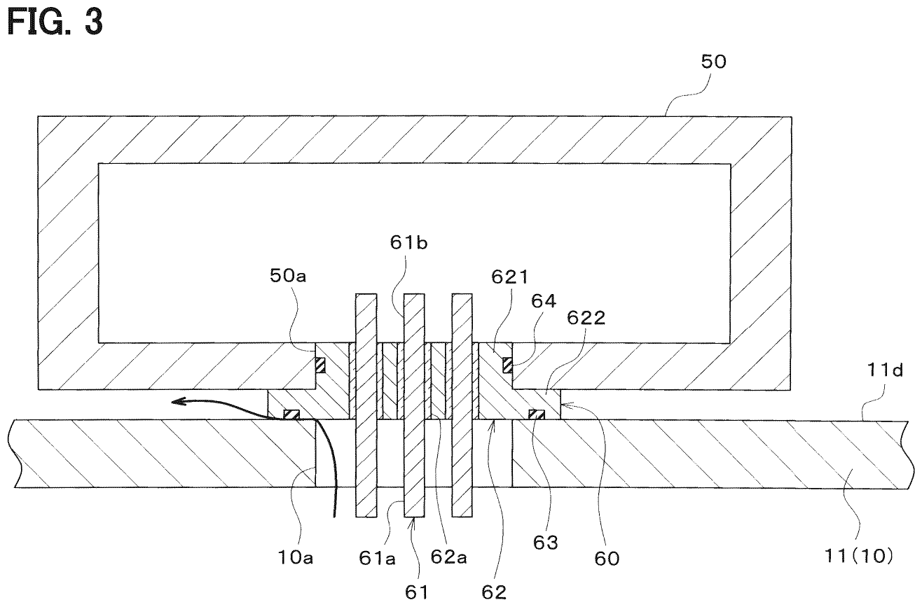

Next, the second embodiment of the present disclosure will be described with reference to FIG. 3. In the present embodiment, the configuration of the connection between the control box 50 and the hermetic terminal 60 differs from that in the first embodiment. FIG. 3 is a diagram corresponding to FIG. 2 described in the above first embodiment.

As shown in FIG. 3, in the present embodiment, the fixing plate 62 of the hermetic terminal 60 includes a projecting portion 621 that is disposed inside the box-side through-hole 50a of the control box 50. In other words, the fixing plate 62 includes: a flat plate portion 622, which is shaped in a flat plate form; and the projecting portion 621, which projects from the flat plate portion 622 toward the control box 50. In the present embodiment, the projecting portion 621 and the flat plate portion 622 are integrally formed in one-piece.

The projecting portion 621 is shaped in a form that corresponds to the box-side through-hole 50a. An outer diameter of the projecting portion 621 is slightly smaller than an inner diameter of the box-side through-hole 50a.

Each of the through-holes 62a is continuously formed from the flat plate portion 622 through the projecting portion 621. That is, each of the through-holes 62a is formed to penetrate both the flat plate portion 622 and the projecting portion 621. The O-ring 64 is provided between an outer peripheral surface of the projecting portion 621 and an inner wall surface of the box-side through-hole 50a.

The rest of the structure of the present embodiment is the same as that of the first embodiment. Accordingly, in the compressor 1 of the second embodiment, the same advantages as those of the first embodiment can be obtained.

### Third Embodiment

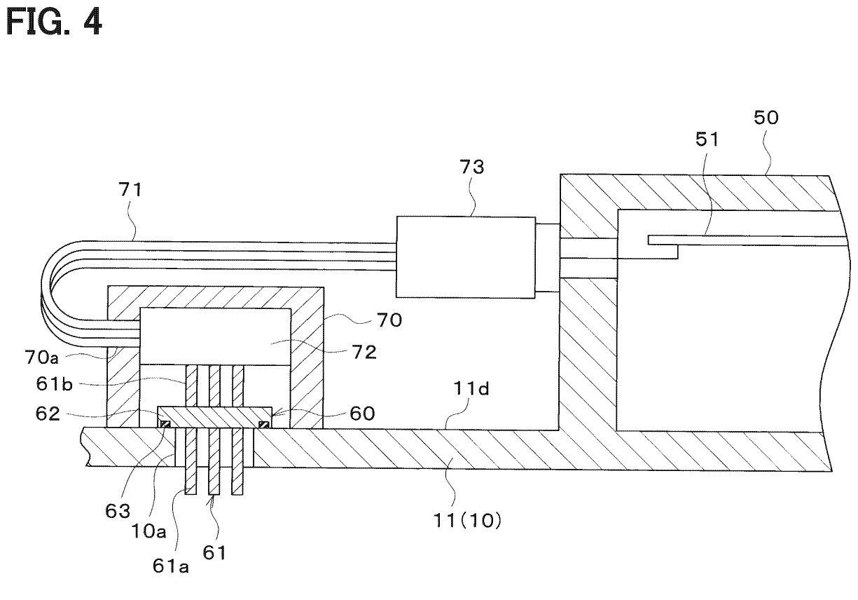

Next, the third embodiment of the present disclosure will be described with reference to FIG. 4. In the present embodiment, the structure of the connection between the housing 10 and the control box 50 is different from that in the first embodiment. FIG. 4 is a diagram corresponding to FIG. 2 described in the above first embodiment.

As shown in FIG. 4, in the present embodiment, the hermetic terminal 60 is received in a waterproof box 70 that has a waterproof structure which is configured to limit intrusion of water into an inside of the waterproof box 70. The waterproof box 70 is disposed outside the control box 50 on the flat surface 11d of the front housing 11. The electrical conductor pins 61 of the hermetic terminal 60 in the waterproof box 70 are electrically connected to the electric circuit board 51 in the control box 50 via a harness 71.

More specifically, the fixing plate 62, the box-side end portions 61b of the electrical conductor pins 61 and an internal connector 72 are arranged in an inside of the waterproof box 70. The internal connector 72 is an electrical connection that electrically connects between the box-side end portions 61b of the electrical conductor pins 61 and the harness 71. The harness 71 is led out to the outside of the waterproof box 70 through a harness through-hole 70a formed in a side portion of the waterproof box 70.

A waterproof connector 73, which is configured to limit intrusion of water into an inside of the waterproof connector 73, is provided at a connecting portion of the harness 71 connected to the control box 50. Therefore, in the present embodiment, the electrical conductor pins 61 are connected to the electric circuit board 51 via the waterproof connector 73.

As described above, in the compressor 1 of the third embodiment, the hermetic terminal 60 is received in the waterproof box 70 provided outside the control box 50, and the electrical conductor pins 61 are connected to the electric circuit board 51 via the harness 71 and the waterproof connector 73. According to this configuration, the connection between the housing 10 and the hermetic terminal 60 can be spaced away from the control box 50. As a result, even when a minute amount of the flammable refrigerant leaks to the surrounding atmosphere through the gasket 63, the leaked flammable refrigerant can be more reliably limited from flowing into the control box 50.

### Fourth Embodiment

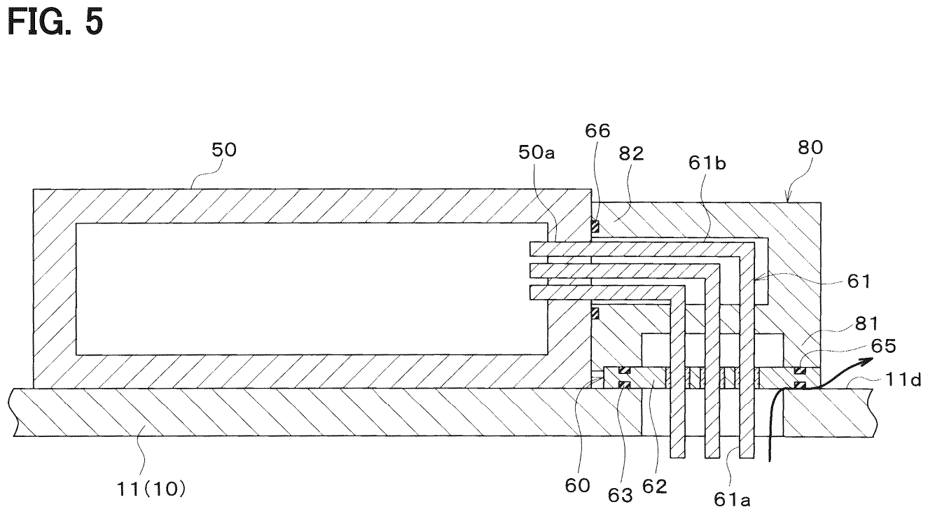

Next, the fourth embodiment of the present disclosure will be described with reference to FIG. 5. In the present embodiment, the structure of the connection between the housing 10 and the control box 50 is different from that in the first embodiment. FIG. 5 is a diagram corresponding to FIG. 2 described in the above first embodiment.

As shown in FIG. 5, in the present embodiment, an external connector 80, which has a waterproof structure for limiting intrusion of water into an inside of the external connector 80, is provided at a connection between the front housing 11 of the housing 10 and the control box 50. That is, the housing 10 and the control box 50 are connected via the external connector 80.

The electrical conductor pins 61 of the hermetic terminal 60 are inserted through the interior of the external connector 80. More specifically, the box-side end portions 61b of the electrical conductor pins 61 are inserted through the interior of the external connector 80.

The external connector 80 includes: a vessel-side connecting portion 81, which is coupled to the housing 10; and a box-side connecting portion 82, which is coupled to the control box 50. The hermetic terminal 60 is provided at a connection between the vessel-side connecting portion 81 and the housing 10. The gasket 63 is provided between the fixing plate 62 of the hermetic terminal 60 and the housing 10.

A first O-ring 65 is provided between the vessel-side connecting portion 81 and the fixing plate 62. The first O-ring 65 is a seal which limits inflow of the air from the surrounding atmosphere into the inside of the external connector 80. In the present embodiment, the first O-ring 65, which is made of a rubber material, is employed.

A plurality of box-side through-holes 50a are formed through a portion of the control box 50, which corresponds to the box-side connecting portion 82. In the present embodiment, the plurality of box-side through-holes 50a are formed to correspond to the plurality of electrical conductor pins 61, respectively. That is, the number of the box-side through-holes 50a is the same as the number of the electrical conductor pins 61.

Each of the electrical conductor pins 61 is inserted through the corresponding one of the box-side through-holes 50a. An inner diameter of each of the box-side through-holes 50a is slightly larger than an outer diameter of the corresponding one of the electrical conductor pins 61. A distal end portion of the box-side end portion 61b of each of the electrical conductor pins 61 is electrically connected to the electric circuit board (not shown) in the inside of the control box 50.

A second O-ring 66 is provided between the box-side connecting portion 82 and the control box 50. The second O-ring 66 is a box-side seal configured to limit inflow of the air from the surrounding atmosphere into the inside of the control box 50. In the present embodiment, the second O-ring 66, which is made of a rubber material, is employed.

As described above, in the compressor 1 of the fourth embodiment, the housing 10 and the control box 50 are connected via the external connector 80. According to this configuration, the connection between the housing 10 and the hermetic terminal 60 can be spaced away from the control box 50. As a result, even when a minute amount of the flammable refrigerant leaks to the surrounding atmosphere through the gasket 63, the leaked flammable refrigerant can be more reliably limited from flowing into the control box 50.

The present disclosure is not limited to the above-described embodiments and may be modified in various ways as follows without departing from the spirit of the present disclosure.
(1) For example, in the above-described embodiments, there is described the example in which the three electrical conductor pins 61 are provided in the hermetic terminal 60. However, the number of the electrical conductor pins 61 is not limited to this. A single electrical conductor pin 61 may be provided, or two, four or more electrical conductor pins 61 may be provided.
(2) In the above-described embodiments, there is described the example, in which the gasket 63 is made of the rubber material. However, the material of the gasket 63 is not limited to this. The gasket 63 may be made of another material that allows slight permeation of the flammable refrigerant. For example, an elastomer, which allows slight permeation of the flammable refrigerant through it, may be used to form the gasket 63.

### Others

The aspects of the electric compressor disclosed in the present specification are as follows.

(Aspect 1)

According to aspect 1 of the present disclosure, there is provided an electric compressor including:
a pressure vessel (10) that receives:
   an electric motor unit (30) which is configured to rotate upon receiving electric power; and
   a compression mechanism (20) which is configured to be driven by the electric motor unit to compress and discharge a flammable fluid;
a control box (50) that receives an electric circuit board (51) which is configured to supply the electric power to the electric motor unit; and
a hermetic terminal (60) that includes at least one electrical conductor pin (61) which electrically connects between the electric motor unit and the electric circuit board and is glass-sealed in a fixing plate (62) that is shaped in a flat plate form and holds the at least one electrical conductor pin, wherein:
the pressure vessel and the control box are integrally formed; and
a vessel-side seal (63) is disposed between the fixing plate and the pressure vessel to limit leakage of the flammable fluid, which is present in the pressure vessel, to a surrounding atmosphere.

(Aspect 2)

According to aspect 2 there is provided the electric compressor according to aspect 1, wherein a box-side seal (64) is disposed to limit inflow of air from the surrounding atmosphere into an inside of the control box.

(Aspect 3)

According to aspect 3, there is provided the electric compressor according to aspect 1 or 2, wherein the vessel-side seal is made of a rubber material.

(Aspect 4)

According to aspect 4, there is provided the electric compressor according to any one of aspects 1 to 3, wherein the at least one electrical conductor pin is connected to the electric circuit board via a waterproof connector (73) which is configured to limit intrusion of water into an inside of the waterproof connector.

Although the present disclosure has been described with reference to the embodiments and the modifications, it is understood that the present disclosure is not limited to the embodiments and the modifications and structures described therein. The present disclosure also includes various variations and variations within the equivalent range. Also, various combinations and forms, as well as other combinations and forms that include only one element, more, or less, are within the scope and ideology of the present disclosure.

What is claimed is:

1. An electric compressor comprising:
a pressure vessel that receives:
an electric motor unit which is configured to rotate upon receiving electric power; and
a compression mechanism which is configured to be driven by the electric motor unit to compress and discharge a flammable fluid;
a control box that receives an electric circuit board which is configured to supply the electric power to the electric motor unit; and
a hermetic terminal that includes at least one electrical conductor pin which electrically connects between the electric motor unit and the electric circuit board and is glass-sealed in a fixing plate that is shaped in a flat plate form and holds the at least one electrical conductor pin, wherein:
the pressure vessel and the control box are integrally formed;
the control box is configured to limit inflow of air from a surrounding atmosphere into an inside of the control box;
the pressure vessel has a vessel-side through-hole which is configured to communicate between an inside space of the pressure vessel and the surrounding atmosphere and receives the at least one electrical conductor pin through the vessel-side through-hole; and
a vessel-side seal is disposed between the fixing plate and the pressure vessel to limit leakage of the flammable fluid, which is present in the pressure vessel, to the surrounding atmosphere through the vessel-side through-hole.

2. The electric compressor according to claim 1, wherein a box-side seal is disposed to limit inflow of the air from the surrounding atmosphere into the inside of the control box.

3. The electric compressor according to claim 1, wherein the vessel-side seal is made of a rubber material.

4. The electric compressor according to claim 1, wherein the at least one electrical conductor pin is connected to the electric circuit board via a waterproof connector which is configured to limit intrusion of water into an inside of the waterproof connector.

5. The electric compressor according to claim 1, wherein a portion of the hermetic terminal, which is disposed outside the pressure vessel, is received in a waterproof box that has a waterproof structure which is configured to limit intrusion of water into an inside of the waterproof box.
